(19) United States
(12) Patent Application Publication
(10) Pub. No.: US 2023/0311690 A1
(43) Pub. Date: Oct. 5, 2023

(54) POWER SUPPLY SYSTEM

(71) Applicant: HONDA MOTOR CO., LTD., Tokyo (JP)

(72) Inventors: Taichi INOUE, TOKYO (JP); Naoya SAKAKIBARA, TOKYO (JP)

(21) Appl. No.: 18/127,888

(22) Filed: Mar. 29, 2023

(30) Foreign Application Priority Data
Mar. 31, 2022 (JP) 2022-058566

(51) Int. Cl. B60L 53/60; H02J 7/00; B60L 53/14; B60L 50/60

(52) U.S. Cl. CPC B60L 53/60; H02J 7/007188; B60L 53/14; B60L 50/60

(57) ABSTRACT

When power feeding from a battery to a load is ended, a welding detection unit detects welding of a power feeding contactor, and when the operation of an GBPS is stopped, the welding detection unit detects the welding of the power feeding contactor after a predetermined time has elapsed from when the operation of the GBPS is stopped.

### CROSS-REFERENCE TO RELATED APPLICATIONS

This application is based upon and claims the benefit of priority from Japanese Patent Application No. 2022-058566 filed on Mar. 31, 2022, the contents of which are incorporated herein by reference.

### BACKGROUND OF THE INVENTION

### Field of the Invention

The present invention relates to a power supply system.

### Description of the Related Art

In recent years, research and development have been conducted on charging and power feeding of vehicles equipped with secondary batteries that contribute to improvement in energy efficiency in order to ensure that more people have access to affordable, reliable, sustainable, and modern energy.

JP 2014-193082 A discloses an electric vehicle that performs charging and power feeding. In the electric vehicle, welding (sticking) of a contactor, which is provided between a secondary battery and a charging and feeding port connected to an external load, is detected.

### SUMMARY OF THE INVENTION

In the technique disclosed in JP 2014-193082 A, there is a problem that the welding of the contactor cannot be detected if the power feeding circuit stops during power feeding.

An object of the present invention is to solve the aforementioned problem.

According to an aspect of the present invention, there is provided a power supply system in an electric vehicle, the power supply system comprising: a charging and feeding port to which a power source outside the electric vehicle or a load outside the electric vehicle is connected; a battery configured to store electric power; a charging circuit provided between the battery and the charging and feeding port, and configured to supply electric power of the power source to the battery; a power feeding circuit provided between the battery and the charging and feeding port, and configured to supply the electric power of the battery to the load; an operation state acquisition unit configured to acquire an operation state of the power feeding circuit; a contactor provided between the power feeding circuit and the charging and feeding port, and configured to switch between a conduction state in which the power feeding circuit and the charging and feeding port are electrically connected to each other, and an interruption state in which the power feeding circuit and the charging and feeding port are electrically disconnected from each other; a welding detection unit configured to detect welding of the contactor to determine whether or not the contactor is welded; and a charging/feeding prohibition control unit configured to prohibit charging of the battery and power feeding to the load in a case where the contactor is determined to be welded, wherein the welding detection unit detects the welding of the contactor in a case where the power feeding from the battery to the load is ended, and in a case where an operation of the power feeding circuit is stopped, the welding detection unit detects the welding of the contactor after a predetermined time has elapsed from when the operation of the power feeding circuit is stopped.

According to the present invention, it is possible to detect welding of the contactor even when the power feeding circuit stops during power feeding.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a circuit diagram of a power supply system;

FIG. 2 is a block diagram of a control device;

FIG. 3 is a flowchart showing a power feeding control process executed by the control device; and

FIG. 4 is a flowchart showing the power feeding control process executed by the control device.

### DETAILED DESCRIPTION OF THE INVENTION

### First Embodiment

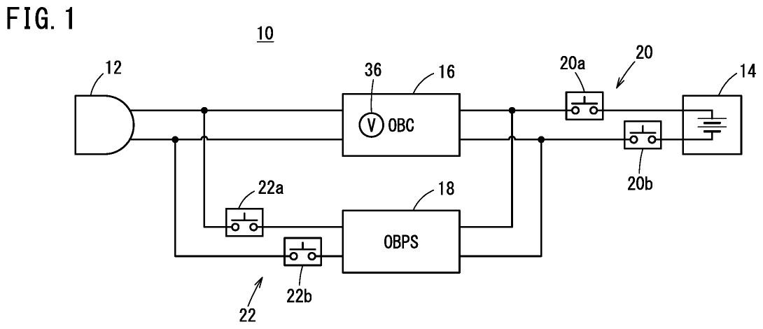

FIG. 1 is a circuit diagram of a power supply system 10 of the present embodiment. The power supply system 10 is mounted on an electric vehicle. A charging and feeding port 12 of the electric vehicle is connected to an external power source. A battery 14 is charged with electric power supplied from the power source. An external load is connected to the charging and feeding port 12 of the electric vehicle. The load is operated by electric power supplied from the battery 14. The battery 14 is a secondary battery, specifically, a lithium ion battery. The battery 14 is also used as a power source of a drive motor of the electric vehicle.

An on-board charger 16 (hereinafter referred to as OBC 16) is provided between the charging and feeding port 12 and the battery 14. The OBC 16 includes an inverter, a transformer, and the like. The OBC 16 converts the AC power supplied from the power source into DC power, boosts the voltage of the DC power, and outputs the DC power to the battery 14. The OBC 16 corresponds to a charging circuit of the present invention.

An on-board power supply 18 (hereinafter referred to as GBPS 18) is provided in parallel with the OBC 16. The GBPS 18 includes an inverter, an X capacitor, a smoothing capacitor, and the like. The GBPS 18 converts the DC power supplied from the battery 14 into AC power, steps down the voltage of the AC power, and outputs the AC power to the charging and feeding port 12. The GBPS 18 corresponds to a power feeding circuit of the present invention.

A battery contactor 20 is provided between the OBC 16 and the battery 14, and between the GBPS 18 and the battery 14. The battery contactor 20 switches between a conduction state in which a current flows and an interruption state in which the flow of the current is interrupted. The battery contactor 20 includes a contactor 20a provided on a positive line and a contactor 20b provided on a negative line.

A power feeding contactor 22 is provided between the GBPS 18 and the charging and feeding port 12. The power feeding contactor 22 switches between the conduction state in which a current flows and the interruption state in which the flow of the current is interrupted. The power feeding contactor 22 includes a contactor 22a provided on a voltage line and a contactor 22b provided on a neutral line. The power feeding contactor 22 corresponds to a contactor of the present invention.

The OBC 16 is used when the battery 14 is charged from the external power source, and the GBPS 18 is used when electric power is fed from the battery 14 to the external load. During charging of the battery 14, electric power having a voltage of about 200 V to 240 V is input to the OBC 16. On the other hand, during power feeding from the battery 14, electric power having a voltage of about 100 V to 120 V is output from the GBPS 18.

When electric power from the external power source is input to the GBPS 18 during charging, a voltage equal to or higher than a withstanding voltage may be applied to the X capacitor of the GBPS 18. In addition, when electric power from the external power source is input to the GBPS 18 during charging, an inrush current may flow into the smoothing capacitor of the GBPS 18, and a current equal to or larger than a withstand current may flow through insulated gate bipolar transistors (IGBTs) of the inverter.

Therefore, during charging, the power supply system 10 electrically disconnects the GBPS 18 from the charging and feeding port 12 by the power feeding contactor 22.

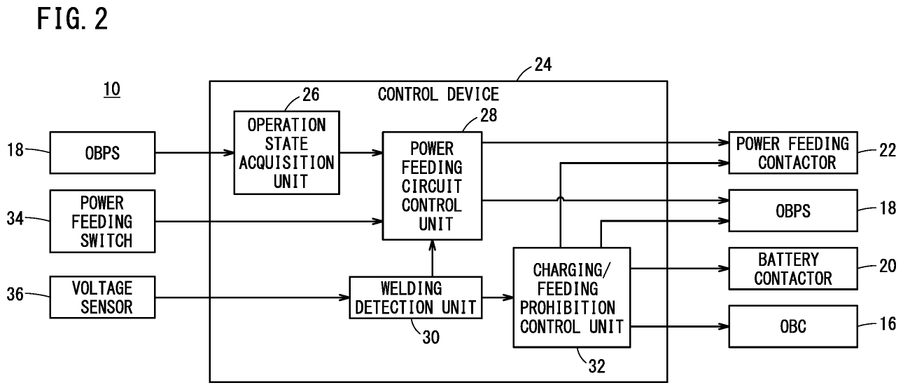

The power supply system 10 includes a control device 24. FIG. 2 is a block diagram of the control device 24. The control device 24 includes an operation state acquisition unit 26, a power feeding circuit control unit 28, a welding detection unit 30, and a charging/feeding prohibition control unit 32.

The operation state acquisition unit 26, the power feeding circuit control unit 28, the welding detection unit 30, and the charging/feeding prohibition control unit 32 are realized by, for example, processing circuitry. The processing circuitry is configured by, for example, an integrated circuit such as an application specific integrated circuit (ASIC) or a field-programmable gate array (FPGA). Further, the processing circuitry may be configured by an electronic circuit including a discrete device.

The processing circuitry may be configured by a processor such as a central processing unit (CPU) or a graphics processing unit (GPU). In this case, the processing circuitry is realized by the processor executing a program stored in a storage unit (not shown).

The operation state acquisition unit 26 acquires the drive signal of the inverter in the GBPS 18. As the duty ratio of the drive signal decreases, the electric power output from the GBPS 18 increases.

In the following cases (1) to (4), the duty ratio of the drive signal becomes 100%, and the GBPS 18 stops:
(1) when the voltage on the output-side of the GBPS 18 is a low voltage
(2) when the voltage on the output-side of the GBPS 18 is an overvoltage
(3) when the temperature of the GBPS 18 is high
(4) when the GBPS 18 fails.

The output-side of the GBPS 18 indicates a side where the GBPS 18 is connected to the charging and feeding port 12. Factors causing the voltage on the output-side of the GBPS 18 to become a low voltage include an excessive load in the external load, a short circuit in the external load, and the like. Factors causing the voltage on the output-side of the GBPS 18 to become an overvoltage include application of a surge voltage from the external load, and the like. Factors causing the temperature of the GBPS 18 to become high include continuous operation of the GBPS 18 in a high-temperature environment, and the like. Factors causing the GBPS 18 to fail include abnormality of the sensor in the inverter of the GBPS 18, short circuit of the AC wire connected to the GBPS 18, and the like.

In the cases of (1) to (3) described above, the GBPS 18 is restored after a predetermined time has elapsed. After the restoration, the duty ratio of the drive signal of the inverter in the GBPS 18 becomes less than 100%. In the case of (4) described above, the GBPS 18 is not restored, and the duty ratio of the drive signal is maintained at 100%. In the case of (4) described above, a notification prompting a user to bring the vehicle to a dealer or the like for repair may be made.

When a power feeding switch 34 is turned on, power feeding to the external load is started. When the power feeding switch 34 is turned off, power feeding to the external load is ended. The power feeding switch 34 is operated by the user of the electric vehicle.

The power feeding circuit control unit 28 controls the GBPS 18 and the power feeding contactor 22 based on the signal of the power feeding switch 34.

The welding detection unit 30 detects welding of the power feeding contactor 22. When the power feeding switch 34 is turned off and the power feeding is ended, the welding detection unit 30 performs welding detection. When the GBPS 18 is stopped during power feeding, the welding detection unit 30 performs welding detection after a predetermined time has elapsed from the stop of the GBPS 18.

When performing welding detection, the welding detection unit controls the GBPS 18 via the power feeding circuit control unit 28 to output electric power from the GBPS 18. Further, the welding detection unit 30 controls the power feeding contactor 22 via the power feeding circuit control unit 28 to turn on only one of the contactor 22a or the contactor 22b. In this state, when the magnitude of the voltage detected by a voltage sensor 36 provided on the OBC 16 is equal to or greater than a predetermined value, the welding detection unit 30 determines that the power feeding contactor 22 is welded. The welding detection unit 30 controls the power feeding contactor 22 to turn on only the other of the contactor 22a and the contactor 22b. In this state, when the magnitude of the voltage detected by the voltage sensor 36 provided on the OBC 16 is equal to or greater than the predetermined value, the welding detection unit 30 determines that the power feeding contactor 22 is welded.

In the following case, the charging/feeding prohibition control unit 32 prohibits charging of the battery 14 from the external power source and power feeding from the battery 14 to the external load. The following case is a case where the welding detection unit 30 determines that the power feeding contactor 22 is welded, or a case where the GBPS 18 is not restored even after the predetermined time has elapsed from the stop of the GBPS 18. In this case, the charging/feeding prohibition control unit 32 stops the OBC 16 and the GBPS 18. In addition, the charging/feeding prohibition control unit 32 brings the battery contactor 20 and the power feeding contactor 22 into the interruption state.

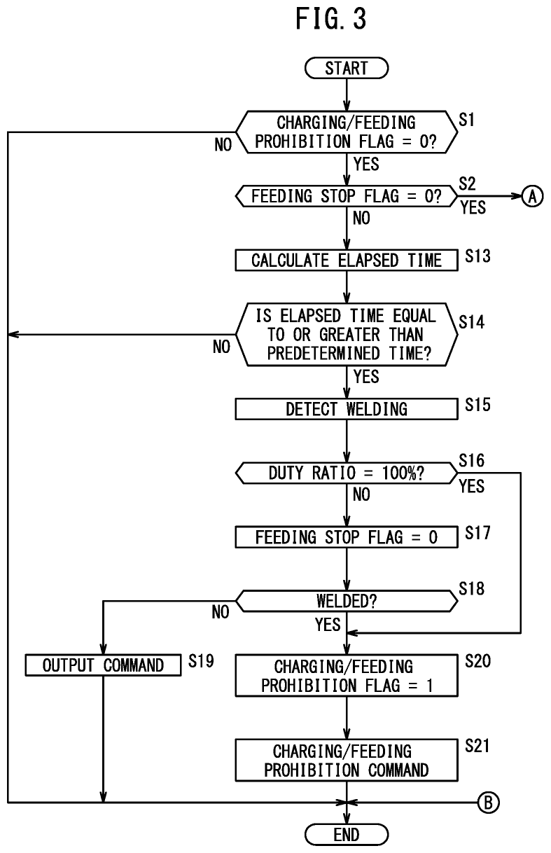

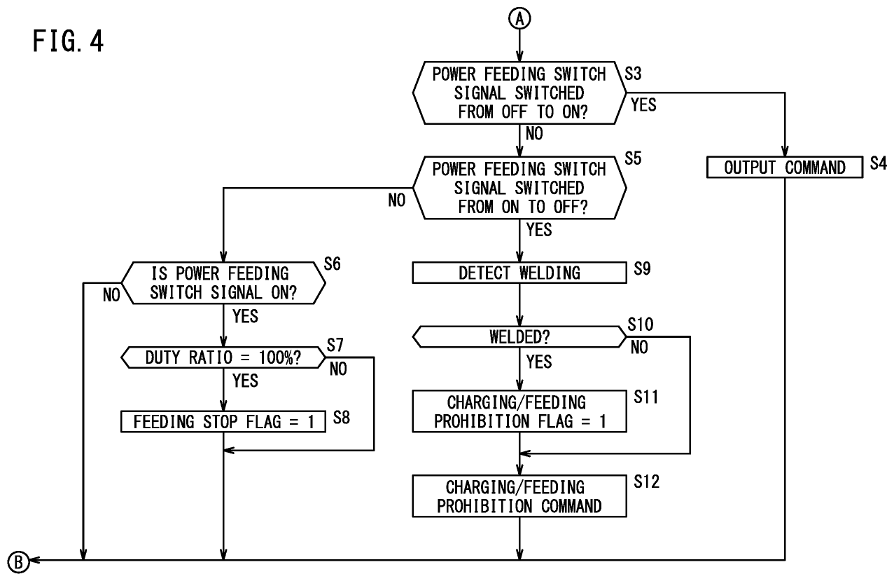

FIGS. 3 and 4 are flowcharts showing a power feeding control process executed by the control device 24. The power feeding control is repeatedly executed at a predetermined cycle.

In step S1, the power feeding circuit control unit 28 determines whether a charging/feeding prohibition flag is “0” or “1”. When the charging/feeding prohibition flag is “0”, the process proceeds to step S2. When the charging/feeding prohibition flag is “1”, the power feeding control is ended.

In step S2, the power feeding circuit control unit 28 determines whether a feeding stop flag is “0” or “1”. When the feeding stop flag is “0”, the process proceeds to step S3. When the feeding stop flag is “1”, the process proceeds to step S13.

In step S3, the power feeding circuit control unit 28 determines whether or not the signal of the power feeding switch 34 has been switched from OFF to ON. When the signal of the power feeding switch 34 has been switched from OFF to ON, the process proceeds to step S4. When the signal of the power feeding switch 34 has not been switched from OFF to ON, the process proceeds to step S5. In a case where the signal of the power feeding switch 34 was OFF when the power feeding control was executed in the previous cycle and the signal of the power feeding switch 34 is ON when the power feeding control is executed in the current cycle, it can be determined that the signal of the power feeding switch 34 has been switched from OFF to ON.

In step S4, the power feeding circuit control unit 28 outputs an output command to the GBPS 18 and the power feeding contactor 22. Thereafter, the power feeding control is ended. Based on the output command, the power feeding contactor 22 is brought into the conduction state. Based on the output command, the GBPS 18 operates.

In step S5, the power feeding circuit control unit 28 determines whether or not the signal of the power feeding switch 34 has been switched from ON to OFF. When the signal of the power feeding switch 34 has been switched from ON to OFF, the process proceeds to step S9. When the signal of the power feeding switch 34 has not been switched from ON to OFF, the process proceeds to step S6. In a case where the signal of the power feeding switch 34 was ON when the power feeding control was executed in the previous cycle and the signal of the power feeding switch 34 is OFF when the power feeding control is executed in the current cycle, it can be determined that the signal of the power feeding switch 34 has been switched from ON to OFF.

In step S6, the power feeding circuit control unit 28 determines whether the signal of the power feeding switch 34 is ON or OFF. When the signal of the power feeding switch 34 is ON, the process proceeds to step S7. When the signal of the power feeding switch 34 is OFF, the power feeding control is ended.

In step S7, the power feeding circuit control unit 28 determines whether the duty ratio of the drive signal of the inverter in the GBPS 18 is 100% or less than 100%. When the duty ratio is 100%, the process proceeds to step S8. When the duty ratio is less than 100%, the power feeding control is ended. When the signal of the power feeding switch 34 is ON, the power feeding circuit control unit 28 monitors the operation of the GBPS 18 in the power feeding control in each cycle. When the duty ratio of the drive signal of the inverter is 100%, the power feeding circuit control unit 28 determines that the GBPS 18 is stopped. When the duty ratio of the drive signal of the inverter is less than 100%, the power feeding circuit control unit 28 can determine that the GBPS 18 is operating.

In step S8, the power feeding circuit control unit 28 sets the feeding stop flag to “1”. Thereafter, the power feeding control is ended. The feeding stop flag being “1” indicates that the GBPS 18 is stopped.

When the power feeding switch 34 is operated and the signal thereof is switched from ON to OFF, the welding detection unit 30 performs welding detection on the power feeding contactor 22 in step S9. Thereafter, the process proceeds to step S10.

In step S10, the welding detection unit 30 determines whether or not the power feeding contactor 22 is welded. When the power feeding contactor 22 is welded, the process proceeds to step S11. When the power feeding contactor 22 is not welded, the process proceeds to step S12.

In step S11, the charging/feeding prohibition control unit 32 sets the charging/feeding prohibition flag to “1”. Thereafter, the process proceeds to step S12. For example, when the electric vehicle is brought to a dealer or the like and the power supply system 10 is repaired, the charging/feeding prohibition flag is set to “0”.

In step S12, the charging/feeding prohibition control unit 32 outputs a charging/feeding prohibition command. Thereafter, the power feeding control is ended. Based on the charging/feeding prohibition command, the battery contactor 20 and the power feeding contactor 22 are controlled to be brought into the interruption state. Based on the charging/feeding prohibition command, the OBC 16 and the GBPS 18 are stopped.

When the GBPS 18 is stopped, the power feeding circuit control unit 28 calculates an elapsed time in step S13. The elapsed time indicates a time from when the GBPS 18 is stopped to when the processing of step S13 is performed. Every time the processing of step S13 is performed, the power feeding circuit control unit 28 can calculate the elapsed time by adding the time of one cycle of the power feeding control to the elapsed time calculated in the previous cycle.

In step S14, the power feeding circuit control unit 28 determines whether the elapsed time is equal to or greater than a predetermined time or less than the predetermined time. When the elapsed time is equal to or greater than the predetermined time, the process proceeds to step S15. When the elapsed time is less than the predetermined time, the power feeding control is ended.

When the predetermined time or more has elapsed from the stop of the GBPS 18, the welding detection unit 30 performs welding detection on the power feeding contactor 22 in step S15. Thereafter, the process proceeds to step S16.

In step S16, the power feeding circuit control unit 28 determines whether the duty ratio of the drive signal of the inverter in the GBPS 18 is 100% or less than 100%. When the duty ratio is 100%, the process proceeds to step S20. When the duty ratio is less than 100%, the process proceeds to step S17.

In step S17, the power feeding circuit control unit 28 sets the feeding stop flag to “0”. Thereafter, the process proceeds to step S18.

In step S18, the welding detection unit 30 determines whether or not the power feeding contactor 22 is welded. When the power feeding contactor 22 is welded, the process proceeds to step S20. When the power feeding contactor 22 is not welded, the process proceeds to step S19.

In step S19, the power feeding circuit control unit 28 outputs an output command to the GBPS 18 and the power feeding contactor 22. Thereafter, the power feeding control is ended. Based on the output command, the power feeding contactor 22 is brought into the conduction state. Based on the output command, the GBPS 18 operates.

In step S20, the charging/feeding prohibition control unit 32 sets the charging/feeding prohibition flag to “1”. Thereafter, the process proceeds to step S21.

In step S21, the charging/feeding prohibition control unit 32 outputs a charging/feeding prohibition command. Thereafter, the power feeding control is ended. Based on the charging/feeding prohibition command, the battery contactor 20 and the power feeding contactor 22 are controlled to be brought into the interruption state. Based on the charging/feeding prohibition command, the OBC 16 and the GBPS 18 are stopped.

### Advantageous Effects

In the cases of (1) to (4) described above, the GBPS 18 stops in order to protect the GBPS 18. While the GBPS 18 is stopped, detection of the welding of the power feeding contactor 22 cannot be performed. However, in the cases of (1) to (3) described above, the GBPS 18 is restored after the predetermined time has elapsed.

Therefore, in the power supply system 10 of the present embodiment, the welding detection unit 30 performs the welding detection after the predetermined time has elapsed from the stop of the GBPS 18. As a result, even after the GBPS 18 is stopped, detection of the welding of the power feeding contactor 22 can be performed. This in turn contributes to improvement in energy efficiency.

Further, in the power supply system 10 of the present embodiment, if the GBPS 18 is not restored even after the predetermined time has elapsed from the stop of the operation of the GBPS 18, the charging/feeding prohibition control unit 32 prohibits charging of the battery 14 from the external power source and power feeding from the battery 14 to the external load. When the GBPS 18 is not restored, it is determined that the GBPS 18 has failed, and the charging/feeding prohibition control unit 32 can prohibit charging of the battery 14 from the external power source and power feeding from the battery 14 to the external load.

The present invention is not limited to the above disclosure, and various modifications are possible without departing from the essence and gist of the present invention.

### Invention Obtained from Embodiment

The invention that can be grasped from the above embodiment will be described below.

Provided is the power supply system (10) in the electric vehicle, the power supply system including: the charging and feeding port (12) to which the power source outside the electric vehicle or the load outside the electric vehicle is connected; the battery (14) configured to store electric power; the charging circuit (16) provided between the battery and the charging and feeding port, and configured to supply electric power of the power source to the battery; the power feeding circuit (18) provided between the battery and the charging and feeding port, and configured to supply the electric power of the battery to the load; the operation state acquisition unit (26) configured to acquire the operation state of the power feeding circuit; the contactor (22) provided between the power feeding circuit and the charging and feeding port, and configured to switch between the conduction state in which the power feeding circuit and the charging and feeding port are electrically connected to each other, and the interruption state in which the power feeding circuit and the charging and feeding port are electrically disconnected from each other; the welding detection unit (30) configured to detect welding of the contactor to determine whether or not the contactor is welded; and the charging/feeding prohibition control unit (32) configured to prohibit charging of the battery and power feeding to the load in a case where the contactor is determined to be welded, wherein the welding detection unit detects the welding of the contactor in a case where the power feeding from the battery to the load is ended, and in a case where the operation of the power feeding circuit is stopped, the welding detection unit detects the welding of the contactor after the predetermined time has elapsed from when the operation of the power feeding circuit is stopped. According to this feature, even after the power feeding circuit is stopped, detection of the welding of the contactor can be performed.

In the above-described power supply system, in a case where the power feeding circuit is not restored after the predetermined time has elapsed from when the operation of the power feeding circuit is stopped, the charging/feeding prohibition control unit may prohibit the charging of the battery and the power feeding to the load. According to this feature, if the power feeding circuit is not restored, it is determined that the power feeding circuit has failed, and charging and power feeding can be prohibited.

1. A power supply system in an electric vehicle, the power supply system comprising:
a charging and feeding port to which a power source outside the electric vehicle or a load outside the electric vehicle is connected;
a battery configured to store electric power;
a charging circuit provided between the battery and the charging and feeding port, and configured to supply electric power of the power source to the battery;
a power feeding circuit provided between the battery and the charging and feeding port, and configured to supply the electric power of the battery to the load;
a contactor provided between the power feeding circuit and the charging and feeding port, and configured to switch between a conduction state in which the power feeding circuit and the charging and feeding port are electrically connected to each other, and an interruption state in which the power feeding circuit and the charging and feeding port are electrically disconnected from each other; and
one or more processing circuitry,
wherein the one or more processing circuitry:
acquire an operation state of the power feeding circuit;
detect welding of the contactor to determine whether or not the contactor is welded;
prohibit charging of the battery and power feeding to the load in a case where the contactor is determined to be welded;
detect the welding of the contactor in a case where the power feeding from the battery to the load is ended; and
in a case where an operation of the power feeding circuit is stopped, detect the welding of the contactor after a predetermined time has elapsed from when the operation of the power feeding circuit is stopped.

2. The power supply system according to claim 1, wherein
in a case where the power feeding circuit is not restored after the predetermined time has elapsed from when the operation of the power feeding circuit is stopped, the one or more processing circuitry prohibit the charging of the battery and the power feeding to the load.
